(19) United States
(12) Patent Application Publication
(10) Pub. No.: US 2020/0040226 A1
(43) Pub. Date: Feb. 6, 2020

(54) ADHESIVE TAPE FOR BATTERIES

(71) Applicant: TERAOKA SEISAKUSHO CO., LTD., Shinagawa-ku, Tokyo (JP)

(72) Inventor: Takashi EDAHIRO, Shinagawa-ku, Tokyo (JP)

(21) Appl. No.: 16/461,717

(22) PCT Filed: Nov. 22, 2016
(86) PCT No.: PCT/JP2016/084599

§ 371 Date: Oct. 16, 2019

(51) Int. Cl. C09J 7/40; H01M 10/04; C09J 7/24; C09J 7/38

(52) U.S. Cl. CPC C09J 7/401; H01M 10/049; C09J 7/243; C09J 7/383; C09J 2483/005; C09J 2423/106; C09J 2409/00; C09J 2433/00; C09J 2203/33; C09J 7/385

(57) ABSTRACT

Disclosed is an adhesive tape for battery capable of increasing the productivity of a battery by improving the battery component insertability, the adhesive tape for battery having a base and an adhesive layer provided on one surface of the base, wherein a release agent is applied on the surface opposite to the surface of the base on which the adhesive layer has been provided, and the maximum value of the static friction coefficient and the dynamic friction coefficient according to JIS K 7125: 1999 of the surface on which the release agent has been applied is 0.6 or less.

### TECHNICAL FIELD

The present invention relates to an adhesive tape for battery, and more particularly to an adhesive tape for battery which can increase the productivity of a battery by improving the battery component insertability.

### BACKGROUND ART

Conventionally, in secondary batteries such as lead storage batteries, nickel-cadmium batteries, nickel-hydrogen batteries and lithium ion batteries, an adhesive tape is used for various purposes such as core fixing, electrode outlet insulation, end fixing and insulating spacer. The secondary battery is manufactured, for example, by inserting a group of electrodes into a battery case and confining an electrolyte in the battery case, after fixing elements with an adhesive tape.

Patent Document 1 describes an adhesive tape for secondary battery characterized by having an adhesive layer mainly composed of a rubber component composed of poly-isobutylene rubber and/or butyl rubber and a saturated hydrocarbon resin, as a layer having a thickness of 10 to 50 μm when dried, on the surface of a polypropylene film base having a thickness of 30 to 300 μm. Then, the adhesive tape is described as being stable to an electrolyte and capable of maintaining the output of a battery at high level over a long period of time.

Patent Document 2 describes an adhesive tape for battery used in a non-aqueous electrolyte secondary battery, having an adhesive layer on at least one surface of a base, wherein the thickness change rate after immersing in an ethylene carbonate/diethyl carbonate mixed solvent for 8 hours at 60° C. is 20% or less and the 180° peel adhesion after the immersion is 0.5 N/10 mm or more. Then, this adhesive tape is described as not causing deterioration of electrolyte properties, not causing destruction of positive and negative electrode active materials and separators due to pressure and decrease in adhesion between current collectors and the active materials, and being capable of improving packing suitability of the electrode into the battery case.

In recent years, with the miniaturization of terminals typified by wearable terminals, the miniaturization of batteries has progressed, and the space on the surface of a group of electrodes and inside a battery case has also become smaller. Therefore, the reduction in thickness is required also for an adhesive tape for battery.

However, the present inventors thought that merely thinning the conventional adhesive tape as described in Patent Documents 1 and 2 was not necessarily sufficient for the application used in a miniaturized battery. Specifically, we focused for example on a problem that when inserting battery components such as a group of electrodes into a space such as the inside of a battery case in a battery manufacturing process, if an adhesive tape is used on the surface of battery components such as a group of electrodes or inside the space, insertion thereof is very difficult. Conventional adhesive tapes have poor battery component insertability, which may possibly lower the productivity of the battery. Such problems have not been studied at all in Patent Documents 1 and 2.

### RELATED ART DOCUMENTS

### Patent Documents

Patent Document 1: JP H9-165557 A

Patent Document 2: JP 2013-140765 A

### SUMMARY OF INVENTION

### Technical Problem

The present invention aims to solve the above problems. That is, an object of the present invention is to provide an adhesive tape for battery which can increase the productivity of a battery by improving the battery component insertability.

### Solution to Problem

As a result of intensive studies to achieve the above object, the inventors of the present invention have found that it is very effective to apply a release agent to one surface of a base constituting an adhesive tape and to adjust the friction coefficient of the coated surface to a specific range, leading to completion of the present invention.

That is, the present invention is an adhesive tape for battery having a base and an adhesive layer provided on one surface of the base, wherein a release agent is applied on the surface opposite to the surface of the base on which the adhesive layer has been provided, and the maximum value of the static friction coefficient and the dynamic friction coefficient according to JIS K 7125: 1999 of the surface on which the release agent has been applied is 0.6 or less.

### Advantageous Effects of Invention

According to the present invention, an adhesive tape for battery which can increase the productivity of a battery by improving the battery component insertability can be provide. Specifically, for example, even if an adhesive tape is used on the surface of a group of electrodes or inside a battery case when inserting the group of electrodes into the battery case, the group of electrodes can be inserted into the battery case very smoothly since the friction coefficient on the surface of the base of the adhesive tape is low. Therefore, the adhesive tape of the present invention is very useful in increasing the productivity of a miniaturized or thinned battery.

### MODES FOR CARRYING OUT THE INVENTION

### [Base]

The type of the base of the adhesive tape of the present invention is not particularly limited, and various bases known to be usable for the adhesive tape can be used. In particular, plastic films are preferred. Specific examples thereof include polyolefin films such as s polyethylene film and a polypropylene film; and a polyethylene terephthalate film, a polybutylene terephthalate film, a polyphenylene sulfide film, a polyimide film and a polyamide film. If necessary, the base may be subjected to treatments such as a corona treatment, a plasma treatment, a flame treatment and an anchor agent treatment. Among them, the polyolefin film and the polyimide film are preferable in terms of heat resistance and chemical resistance suitable for the battery application.

The thickness of the base is preferably 4 to 200 μm, more preferably 6 to 100 μm, and particularly preferably 15 to 60 μm.

### [Release Agent]

A release agent is applied to one surface (the surface opposite to the surface provided with the adhesive layer) of the base of the adhesive tape of the present invention. The type of the release agent is not particularly limited, and various known release agents can be used. As the release agent, long chain alkyl-based and silicone-based release agents are preferable, and particularly, long chain alkyl-based release agents are preferable.

As the long chain alkyl-based release agent, for example, polymers of alkyl acrylates having a long chain alkyl group, copolymers of alkyl acrylates having a long chain alkyl group and other vinyl monomers and the reaction products obtained by reacting polyvinyl alcohols with long chain alkyl isocyanates can be used. The carbon atom number of the long chain alkyl group is preferably 12 or more, more preferably 12 to 22. A commercially available product can also be used as the long chain alkyl-based release agent. A specific example of the commercially available product is “Peeloil (registered trademark) 1010” manufactured by Lion Specialty Chemicals Co., Ltd., which is an organic solvent-soluble long chain alkyl-based release agent having a long chain alkyl pendant polymer as a main component. The dry application amount of the long chain alkyl-based release agent (solid content after application and drying) is preferably 0.001 to 0.5 g/m², more preferably 0.02 to 0.45 g/m², particularly preferably 0.03 to 0.40 g/m².

As the silicone-based release agent, for example, silicone-based release agents of addition reaction type, condensation reaction type, cationic polymerization type or radical polymerization type can be used. Among them, an addition reaction type silicone-based release agent containing a release agent component which cures by addition polymerization is preferable. Commercially available products can also be used as the silicone-based release agent. A specific example of the commercially available product is “KS-847T” (trade name) manufactured by Shin-Etsu Chemical Co., Ltd, which is an addition reaction type silicone-based release agent mainly composed of a release agent component that can be cured by the addition polymerization of an alkenyl group and an SiH group. The dry application amount of the silicone-based release agent (solid content after application and drying) is preferably 0.1 to 0.4 g/m², more preferably 0.1 to 0.3 g/m², particularly preferably 0.1 to 0.25 g/m².

In the present invention, the maximum value of the static friction coefficient and dynamic friction coefficient according to JIS K 7125 of the surface of the base on which the release agent has been applied is 0.6 or less, preferably 0.5 or less, more preferably 0.4 or less, particularly preferably 0.3 or less. Specific conditions of the method of measuring the friction coefficient are described in the column of Examples. In the present invention, the maximum value of the static friction coefficient and the dynamic friction coefficient is within such a specific range, so that the battery component insertability can be remarkably improved.

Among conventional adhesive tapes, there are also adhesive tapes in which a release agent is applied to one surface of a base. However, the purpose of the release agent application in this case is to easily rewind the wound adhesive tape. That is, since it becomes difficult to rewind when the base of the lower adhesive tape and the adhesive layer of the upper adhesive tape in the wound state are strongly adhered, so the release agent is applied to the upper side of the base, to relax the peel adhesion. On the other hand, the object of the present invention is not to improve the rewindability but to improve the battery component insertability. The product design for improving the rewindability of the conventional adhesive tape is different from the product design for improving the battery component insertability of the present invention.

For example, in order to improve the rewindability, a large amount of release agent may be applied, but the maximum value of the static friction coefficient and dynamic friction coefficient does not always decrease if a large amount of release agent is applied. In fact, in examples to be described later, there is also a type of release agent by which the maximum value of the static friction coefficient and dynamic friction coefficient becomes higher when a large amount is applied. Moreover, the maximum value of the static friction coefficient and dynamic friction coefficient is influenced not only by the amount and type of the release agent but also by the friction coefficient inherent to the base itself (friction coefficient of the base surface before applying the release agent). Therefore, in the present invention, in order to set the maximum value of the static friction coefficient and dynamic friction coefficient within the above-described specific range, the types of the release agent and the base are appropriately selected, and the amount of the release agent is appropriately adjusted. The maximum value of the static friction coefficient and dynamic friction coefficient of the base itself (base prior to applying the release agent) is preferably 1.5 or less, and more preferably 1.0 or less. [Adhesive Layer]

As an adhesive constituting the adhesive layer of the adhesive tape of the present invention, for example, a rubber-based adhesive, an acrylic adhesive and a silicone-based adhesive can be used. These may be used each singly or in admixture of two or more types.

The type of the rubber-based adhesive is not particularly limited, and various known rubber-based adhesives containing a rubber component as a main component can be used. Specific examples of the rubber component include synthetic rubbers such as butyl rubber, polyisobutylene rubber, isoprene rubber, styrene-isobutylene-styrene triblock copolymer, styrene-isoprene block copolymer, styrene-butadiene rubber, styrene isoprene-styrene block copolymer, styrene-butadiene-styrene block copolymer, styrene-ethylene-butylene-styrene block copolymer, styrene-ethylene-propylene-styrene block copolymer and styrene-ethylene-propylene block copolymer rubber; and natural rubbers. Two or more rubber components may be used in combination. In particular, synthetic rubbers are preferable, and butyl rubber, polyisobutylene rubber, or a mixture thereof is more preferable, from the viewpoint of characteristics such as heat resistance, chemical resistance, weather resistance and insulation. The butyl rubber is generally a rubber containing, as a main component, a copolymer of isobutylene and 1 to 3% by mass of isoprene.

When a rubber-based adhesive is used for the adhesive layer, it is preferable to further blend a saturated hydrocarbon resin. The saturated hydrocarbon resin is a hydro-carbon resin having no unsaturated bond, and is a component for improving the adhesiveness of the adhesive layer. Since the saturated hydrocarbon resin is a resin composed only of a saturated hydrocarbon, when using an adhesive tape, for example, in a portion immersed in an electrolyte in a secondary battery or in a portion which may come in contact with an electrolyte, a decomposition reaction hardly occurs even under high voltage and high energy when repeating charging and discharging, thus, excellent stability is exhibited.

The type of the saturated hydrocarbon resin is not particularly limited, and for example, various alicyclic or aliphatic saturated hydrocarbon resins known as tackifiers can be used. Two or more saturated hydrocarbon resins may be used in combination. In particular, alicyclic saturated hydrocarbon resins are preferable, and hydrocarbon resins in which unsaturated bonds are eliminated by a hydrogenation treatment are more preferable. A commercially available product of the saturated hydrocarbon resin is a hydrogenated petroleum resin. The hydrogenated petroleum resin is a resin obtained by hydrogenating a petroleum resin (e.g., an aromatic petroleum resin, an aliphatic petroleum resin, a copolymer petroleum resin of an alicyclic component and an aromatic component). Among them, a hydrogenated petroleum resin (alicyclic saturated hydrocarbon resin) obtained by subjecting an aromatic petroleum resin to a hydrogenation treatment is preferable. Preferred hydrogenated petroleum resins are available commercially (e.g., ARKON (registered trademark) P-100 manufactured by Arakawa Chemical Industries, Ltd.). The content of the saturated hydrocarbon resin is preferably 0.01 to 100 parts by mass, more preferably 0.01 to 80 parts by mass, particularly preferably 0.01 to 50 parts by mass with respect to 100 parts by mass of the adhesive component. The higher the content of the saturated hydrocarbon resin, the more the adhesiveness is improved.

The type of the acrylic adhesive is not particularly limited, and various known acrylic adhesives containing an acrylic copolymer as a main component can be used. As the acrylic copolymer, for example, acrylic copolymers obtained by copolymerizing a (meth)acrylic acid ester, a carboxyl group-containing monomer, and if necessary, the other monomer, can be used. Specific examples of the (meth)acrylic acid ester include methyl (meth)acrylate, ethyl (meth)acrylate, n-propyl (meth)acrylate, isopropyl (meth)acrylate, n-butyl (meth)acrylate, isobutyl (meth)acrylate, 2-ethylhexyl (meth)acrylate, octyl (meth)acrylate, isooctyl (meth)acrylate, nonyl (meth)acrylate, isononyl (meth)acrylate and lauryl (meth)acrylate. Specific examples of the carboxyl group-containing monomer include (meth)acrylic acid, itaconic acid, crotonic acid, (anhydrous) maleic acid, fumaric acid, 2-carboxy-1-butene, 2-carboxy-1-pentene, 2-carboxy-1-hexene, 2-carboxy-1-heptene and vinyl acetate. Specific examples of the other monomer include hydroxyl group-containing monomers such as 2-hydroxyethyl (meth)acrylate, 3-hydroxypropyl (meth)acrylate and 4-hydroxybutyl (meth)acrylate; and acrylonitrile, styrene and 2-methylolethylacrylamide.

As the acrylic copolymer, particularly preferable are acrylic polymers (A) having a hydroxyl group and a carboxyl group, containing, as a constituent component, a (meth)acrylic acid alkyl ester (A1) having an alkyl group having 4 to 12 carbon atoms, a carboxyl group-containing monomer (A2), a hydroxyl group-containing monomer (A3), and if necessary, a (meth)acrylic acid alkyl ester (A4) having an alkyl group having 1 to 3 carbon atoms.

Specific examples of the (meth)acrylic acid alkyl ester (A1) having an alkyl group having 4 to 12 carbon atoms include n-butyl (meth)acrylate, isobutyl (meth)acrylate, 2-ethylhexyl (meth)acrylate, octyl (meth)acrylate, isooctyl (meth)acrylate, isononyl (meth)acrylate and lauryl (meth)acrylate. The content of the (meth)acrylic acid alkyl ester (A1) is preferably 70% by mass or more, more preferably 80% by mass or more, particularly preferably 90% by mass or more in 100% by mass of the constituent components (monomer units) of the acrylic copolymer (A).

Specific examples of the carboxyl group-containing monomer (A2) include (meth)acrylic acid, itaconic acid, crotonic acid, (anhydrous) maleic acid, fumaric acid, 2-carboxy-1-butene, 2-carboxy-l-pentene, 2-carboxy-1-hexene and 2-carboxy-1-heptene. The content of the carboxyl group-containing monomer (A2) is preferably 0.5 to 10% by mass, more preferably 1 to 7% by mass, particularly preferably 1 to 5% by mass in 100% by mass of the constituent components (monomer units) of the acrylic copolymer (A).

Specific examples of the hydroxyl group-containing monomer (A3) include 2-hydroxyethyl (meth)acrylate, 3-hydroxypropyl (meth)acrylate and 4-hydroxybutyl (meth)acrylate. The content of the hydroxyl group-containing monomer (A3) is preferably 0.05 to 10% by mass, more preferably 0.07 to 7% by mass, particularly preferably 0.1 to 5% by mass in 100% by mass of the constituent components (monomer units) of the acrylic copolymer (A).

Specific examples of the (meth)acrylic acid alkyl ester (A4) having an alkyl group having 1 to 3 carbon atoms include methyl (meth)acrylate, ethyl (meth)acrylate and propyl (meth)acrylate. Among them, methyl (meth)acrylate is preferable. The content of the (meth)acrylic acid alkyl ester (A4) is preferably 0 to 20% by mass, more preferably 0 to 10% by mass, particularly preferably 0 to 5% by mass in 100% by mass of the constituent components (monomer units) of the acrylic copolymer (A).

The acrylic copolymer (A) may contain other monomers than the components (A1) to (A4), as a constituent component.

It is common to use a crosslink agent having reactivity with the functional group of the acrylic copolymer, for the acrylic adhesive. As the crosslink agent, for example, an isocyanate compound, an acid anhydride, an amine compound, an epoxy compound, metal chelates, an aziridine compound and a melamine compound can be used. The addition amount of the crosslink agent is usually 0.01 to 5 parts by mass, preferably 0.05 to 3 parts by mass with respect to 100 parts by mass of the acrylic copolymer.

In the acrylic adhesives, if necessary, tackifier resins such as rosin type, terpene type, petroleum type, coumarone/indene type, pure monomer type, phenol type and xylene type; mineral oils such as paraffinic type process oils, polyester type plasticizers, and softeners containing, for example, vegetable oils; and anti-aging agent such as aromatic secondary amine type, monophenol type, bisphenol type, polyphenol type, benzimidazole type and phosphorous acid type, may be added. Further, the above-mentioned saturated hydrocarbon resins may be blended.

The type of the silicone-based adhesive is not particularly limited, and various known silicone-based adhesives containing a silicone component as a main component can be used. As the silicone component, for example, silicone rubbers and silicone resins which have organopolysiloxane as a main component are mentioned. Into such a silicone component, a catalyst such as a platinum catalyst and a crosslink agent such as a siloxane-based crosslink agent or a peroxide-based crosslink agent may be added to perform crosslinking/polymerization. Further, the above-mentioned saturated hydrocarbon resins may be blended.

Each adhesive described above may further contain other components as necessary. Specific examples thereof include solvents such as toluene; additives such as antioxidant, an ultraviolet light absorber, a light stabilizer and an antistatic agent; fillers or pigments such as carbon black, calcium oxide, magnesium oxide, silica, zinc oxide and titanium oxide.

The adhesive layer can be formed, for example, by applying an adhesive on a base and causing a crosslinking reaction by heating. The thickness of the adhesive layer is preferably 1 to 50 μm, more preferably 2 to 40 μm, particularly preferably 3 to 30 μm.

A primer layer may be provided between the base and the adhesive layer. As the primer, for example, a primer containing a polymer in which a polar group is introduced by acid modification and/or an acid component can be used. Specific examples thereof include polymers in which a polar group is introduced by graft modification using a carboxyl group-containing monomer (for example, unsaturated monocarboxylic acids such as acrylic acid and methacrylic acid; unsaturated dicarboxylic acid monoesters such as maleic acid monomethyl ester) or an acid anhydride group-containing monomer (for example, maleic anhydride). The type of the polymer to be modified is not particularly limited, but in particular, polyolefin type polymers such as polypropylene polymers and polyethylene polymers are preferable. Specific examples of the acid component used for the primer layer include organic acids such as organic sulfonic acids and carboxylic acids; and inorganic acids such as sulfuric acid, hydrochloric acid and phosphoric acid. Among these, acid-modified polyolefin type polymers are preferable, and acid-modified polypropylene type polymers are more preferable. The thickness of the primer layer is preferably 0.01 to 5 μm, more preferably 0.1 to 3 μm, particularly preferably 0.2 to 2 μm.

### [Adhesive Tape for Battery]

The adhesive tape of the present invention has a base and an adhesive layer provided on one surface of the base. A release agent is applied to the surface opposite to the surface provided with the adhesive layer, and the maximum value of the static friction coefficient and dynamic friction coefficient according to JIS K 7125 of the surface on which the release agent has been applied is 0.6 or less.

The adhesive tape of the present invention is an adhesive tape for battery. For example, in the battery manufacturing process of secondary batteries (lead storage batteries, nickel-cadmium batteries, nickel-hydrogen batteries or lithium ion batteries), it can be used for various purposes such as core fixing, electrode outlet insulation, end fixing and insulating spacer. Since the adhesive tape of the present invention has a maximum value of the static friction coefficient and dynamic friction coefficient within a specific range, it is excellent in the battery component insertability. For example, even if an adhesive tape is used on the surface of a group of electrodes or inside a battery case when inserting the group of electrodes into the battery case, the group of electrodes can be inserted into the battery case very smoothly since the friction coefficient on the surface of the base of the adhesive tape is low. Therefore, the adhesive tape of the present invention is very useful in increasing the productivity of a miniaturized or thinned battery.

The adhesive layer of the adhesive tape of the present invention is preferably laminated on the inside at a distance of 0.5 mm or more from the both edge portions of the base. According to such an aspect of the inner lamination, it is possible to prevent protrusion of the adhesive, and it becomes an adhesive tape which is very suitable for the battery application.

In general, the adhesive tape is shipped and stored as a wound body. Then, the release agent of the base surface of the lower adhesive tape in the wound state may transfer to the adhesive layer of the upper adhesive tape, and the peel adhesion of the adhesive tape may be reduced. Therefore, the adhesive tape of the present invention has a retention of peeling strength measured by the following method of preferably 70 to 150%, more preferably 75 to 130%, particularly preferably 80 to 120%, most preferably 90 to 110%

### (Retention of Peeling Strength)

To a surface of an adhesive tape (1) on which a release agent has been applied, the adhesive layer side of the same adhesive tape (2) is pasted, and they are aged at 23° C. for 20 hours, then, peeled. Then, the peel adhesion (a) to SUS plate of the adhesive tape (2) according to JIS Z 0237:2000 and the peel adhesion (b) to SUS plate of the adhesive tape (2) when peeled without aging are measured, and the retention of peeling strength is calculated by the following equation.

Retention of peeling strength(%)=(a/b)×100%.

The method for producing the adhesive tape of the present invention is not particularly limited. For example, first, a release agent is applied to one surface of the base. Then, an adhesive may be applied to the other surface, and the solvent may be removed by heating in a process such as drying to form an adhesive layer. Further, if necessary, a release film made of a PET film coated with a release agent may be laminated on the adhesive layer.

The application method of the release agent and the adhesive is not particularly limited, and for example, a method using a roll coater, a die coater, a lip coater, a Mayer bar coater or a gravure coater can be used. The drying method of the release agent and the adhesive is also not particularly limited, and for example, a hot air drying method can be used.

### EXAMPLES

Hereinafter, the present invention will be described in more detail by way of examples. However, the present invention is not limited to these examples.

### Examples 1 to 6

The maximum value of the static friction coefficient and dynamic friction coefficient of a biaxially oriented polypropylene film having a thickness of 20 μm to be used as a base [Torayfan (registered trademark), manufactured by Toray Industries Inc.] (OPP film, before release agent application) was measured by the following method, to find it was 0.43.

(Measurement of Maximum Value of Static Friction Coefficient and Dynamic Friction Coefficient)

The maximum value of the static friction coefficient and dynamic friction coefficient was measured in accordance with JIS K7125. Specifically, using a friction coefficient tester (manufactured by Toyo Seiki Seisaku-sho Ltd.), the static friction coefficient and dynamic friction coefficient were measured under conditions of a weight of a sliding piece of 200 g, a contact area of 6.3 m×6.3 m and a tensile rate of 100 mm/min, and the highest value among them was taken as the “maximum value”.

On one surface of this OPP film, a long chain alkyl-based release agent (Peeloil (registered trademark) 1010, manufactured by Lion Specialty Chemicals, Inc.) as a release agent was applied so that the dry application amount (solid content after application and drying) was as shown in Table 1, and dried. Then, the maximum value of the static friction coefficient and dynamic friction coefficient of the surface of the base on which the release agent had been applied was measured by the same method. The results are shown in Table 1.

This OPP film having undergone the release agent treatment on one surface thereof as described above was used as a base, and on the other surface thereof, a rubber-based adhesive containing 100 parts by mass of butyl rubber (manufactured by Exxon Chemical Co., Ltd, trade name Butyl 365) and 40 parts by mass of a hydrogenated petroleum resin (alicyclic saturated hydrocarbon resin) (manufactured by Arakawa chemical Industries, Ltd., ARKON (registered trademark) P-100) as a main component was applied, and dried, to form an adhesive layer having a thickness of 5 μm, to obtain a rubber-based adhesive tape.

An adhesive layer having a thickness of 10 μm was formed, to obtain acrylic adhesive tape in the same manner as described above, except using an adhesive composition prepared by adding 1 part by mass of an isocyanate type crosslink agent (manufactured by Nippon polyurethane Co., Ltd., Coronate (registered trademark) L) to 100 parts by mass of an acrylic adhesive containing, as a main component, an acrylic polymer containing 60% by mass of 2-ethylhexyl (meth)acrylate, 36.4% by mass of n-butyl acrylate, 3.5% by mass of acrylic acid and 0.1% by mass of 2-hydroxyethyl acrylate as constituent components, instead of the rubber-based adhesive.

### Examples 7 to 8 and Comparative Example 1

A rubber-based adhesive tape and an acrylic adhesive tape were produced in the same manner as in Examples 1 to 6, except that a silicone-based release agent (manufactured by Shin-Etsu Chemical Co., Ltd., KS-847T) was used as a release agent, and applied so that the dry application amount was as shown in Table 2.

### Examples 9 to 10 and Comparative Examples 2 to 3

A rubber-based adhesive tape and an acrylic adhesive tape were produced in the same manner as in Examples 1 to 6, except that a polyimide film having a thickness of 25 μm [manufactured by Toray DuPont Co., Ltd., Kapton (registered trademark) 100H] (PI film, maximum value of friction coefficient=1.45) was used as a base, and a long chain alkyl-based release agent as a release agent was applied so that the dry application amount was as shown in Table 3

### Examples 11 to 12 and Comparative Example 4

A rubber-based adhesive tape and an acrylic adhesive tape were produced in the same manner as in Examples 9 to 10, except that a silicone-based release agent (manufactured by Shin-Etsu Chemical Co., Ltd., KS-847T) was used as a release agent, and applied so that the dry application amount was as shown in Table 4.

### Examples 13 to 17

A rubber-based adhesive tape and an acrylic adhesive tape were produced in the same manner as in Examples 1 to 6, except that a polyethylene terephthalate film having a thickness of 25 μm [manufactured by Toray Industries, Inc., Lumirror (registered trademark)] (PET film, maximum value of friction coefficient=0.81) was used as a substrate, and a long chain alkyl-based release agent as a release agent was applied so that the dry application amount was as shown in Table 5.

The battery component insertability of each adhesive tape of the above Examples 1 to 13 and Comparative Examples 1 to 4 was evaluated. Further, with respect to each adhesive tape of Examples 1 to 8 and Comparative Example 1, the retention of peeling strength was also measured. The evaluation and measurement methods are as follows. The results are shown in Tables 1 to 5.

### (Retention of Peeling Strength)

To a surface of an adhesive tape (1) on which a release agent had been applied, the adhesive layer side of the same adhesive tape (2) was pasted, and they were aged at 23° C. for 20 hours, then, peeled. Then, the peel adhesion (a) to SUS plate of the adhesive tape (2) according to JIS Z 0237:2000 and the peel adhesion (b) to SUS plate of the adhesive tape (2) when peeled without aging were measured, and the retention of peeling strength was calculated by the following equation.

Retention of peeling strength(%)=(a/b)×100%

### (Battery Component Insertability)

A group of wound electrodes for small secondary battery was fixed with an adhesive tape, and the insertability at the time of inserting this into a battery case was evaluated based on the following criteria.

A: The insertion was smooth.

B: The insertion was a little smooth.

C: The smooth insertion was impossible.

TABLE 1

| | | Ex. 1 | Ex. 2 | Ex. 3 | Ex. 4 | Ex. 5 | Ex. 6 |
|---|---|---|---|---|---|---|---|
| Base | | OPP | OPP | OPP | OPP | OPP | OPP |
| Release agent | Release agent | Long | Long | Long | Long | Long | Long |
| layer | | chain | chain | chain | chain | chain | chain |
| | | alkyl | alkyl | alkyl | alkyl | alkyl | alkyl |
| | Dry application | 0.001 | 0.01 | 0.03 | 0.05 | 0.10 | 0.50 |
| | amount (g/m²) | | | | | | |
| Maximum value of friction coefficient | | 0.35 | 0.34 | 0.32 | 0.30 | 0.29 | 0.25 |
| Retention of | Rubber-based adhesive | 99% | 101% | 110% | 105% | 109% | 109% |
| peeling strength | Acrylic adhesive | 97% | 101% | 103% | 98% | 95% | 92% |

| | | | | | | |
|---|---|---|---|---|---|---|
| Battery component insertability | A | A | A | A | A | A |

TABLE 2

| | | | | Com. |
|---|---|---|---|---|
| | | Ex. 7 | Ex. 8 | Ex. 1 |
| Base | | OPP | OPP | OPP |
| Release agent | Release agent | silicone | silicone | silicone |
| layer | Dry application | 0.10 | 0.25 | 0.50 |
| | amount (g/m²) | | | |
| Maximum value of friction coefficient | | 0.19 | 0.30 | 0.70 |
| Retention of | Rubber-based adhesive | 92% | 95% | 109% |
| peeling strength | Acrylic adhesive | 79% | 82% | 94% |

| | | | |
|---|---|---|---|
| Battery component insertability | A | A | C |

TABLE 3

| | | | | Com. | Com. |
|---|---|---|---|---|---|
| | | Ex. 9 | Ex. 10 | Ex. 2 | Ex. 3 |
| Base | | PI | PI | PI | PI |
| Release agent | Release agent | Long | Long | Long | Long |
| layer | | chain | chain | chain | chain |
| | | alkyl | alkyl | alkyl | alkyl |
| | Dry application | 0.03 | 0.05 | 0.001 | 0.01 |
| | amount (g/m²) | | | | |

| | | | | |
|---|---|---|---|---|
| Maximum value of friction coefficient | 0.34 | 0.33 | 0.90 | 0.67 |
| Battery component insertability | A | A | C | B |

TABLE 4

| | | Ex. 11 | Ex. 12 | Comp. Ex. 4 |
|---|---|---|---|---|
| Base | | PI | PI | PI |
| Release agent | Release agent | silicone | silicone | silicone |
| layer | Dry application | 0.10 | 0.25 | 0.50 |
| | amount (g/m² ) | | | |

| | | | |
|---|---|---|---|
| Maximum value of friction coefficient | 0.28 | 0.35 | 0.76 |
| Battery component insertability | A | A | C |

TABLE 5

| Base: PET film | | Ex. 13 | Ex. 14 | Ex. 15 | Ex. 6 | Ex. 17 |
|---|---|---|---|---|---|---|
| Base | | PET | PET | PET | PET | PET |
| Release agent | Release agent | Long | Long | Long | Long | Long |
| layer | | chain | chain | chain | chain | chain |
| | | alkyl | alkyl | alkyl | alkyl | alkyl |
| | Dry application | 0.001 | 0.01 | 0.03 | 0.05 | 0.10 |
| | amount (g/m²) | | | | | |

| | | | | | |
|---|---|---|---|---|---|
| Maximum value of friction coefficient | 0.41 | 0.35 | 0.29 | 0.27 | 0.28 |
| Battery component insertability | A | A | A | A | A |

### <Evaluation Results>

As shown in Tables 1 to 5, the adhesive tapes of Examples 1 to 17 were excellent in the battery component insertability. On the other hand, the adhesive tapes of Comparative Examples 1 to 4 were inferior in the battery component insertability.

In Examples 1 to 6, 9 to 10 and 16 and Comparative Examples 2 to 3 in which long chain alkyl-based release agents were used, the maximum value of the friction coefficient decreased as the amount of the release agent applied was increased. On the other hand, in Examples 7 to 8 and 11 to 12 and Comparative Examples 1 to 4 in which silicone-based release agents were used, the maximum value of the friction coefficient increased conversely as the amount of the release agent applied was increased.

In Examples 1 to 6 in which long chain alkyl-based release agents were used, the retention of peeling strength of the acrylic adhesive decreased as the amount of the release agent applied was increased. This is considered to be due to the transfer of a part of the long chain alkyl-based release agent on the base of the adhesive tape (1) to the adhesive layer of the adhesive tape (2). On the other hand, in Examples 7 to 8 and Comparative Example 1 in which silicone-based release agents were used, the retention of peeling strength increased conversely as the amount of the release agent applied was increased. This is considered to be due to the fact that the silicone-based release agent itself has adhesiveness, although a part of the silicone-based release agent transfers to the adhesive layer. Moreover, in any of Examples 1 to 8 and Comparative Example 1, the adhesive tape using the rubber-based adhesive had a higher retention of peeling strength than the adhesive tape using the acrylic adhesive.

### INDUSTRIAL APPLICABILITY

The adhesive tape for battery of the present invention is excellent in the battery component insertability, so that, for example, in the manufacture of a wound battery, a group of electrodes can be easily inserted into a battery case by using it for fixing the group of wound electrodes. Therefore, it is very useful for increasing the productivity of batteries, particularly small or thin batteries.

1. An adhesive tape for battery having a base and an adhesive layer provided on one surface of the base, wherein a release agent is applied on the surface opposite to the surface of the base on which the adhesive layer has been provided, and the maximum value of the static friction coefficient and the dynamic friction coefficient according to JIS K 7125: 1999 of the surface on which the release agent has been applied is 0.6 or less.

2. The adhesive tape for battery according to claim 1, wherein the release agent is a long chain alkyl-based release agent or a silicone-based release agent.

3. The adhesive tape for battery according to claim 2, wherein the dry application amount of the long chain alkyl-based release agent is 0.001 to 0.5 g/m².

4. The adhesive tape for battery according to claim 2, wherein the dry application amount of the silicone-based release agent is 0.1 to 0.4 g/m².

5. The adhesive tape for battery according to claim 1, wherein the adhesive composition constituting the adhesive layer contains a rubber-based adhesive, an acrylic adhesive or a silicone-based adhesive.

6. The adhesive tape for battery according to claim 5, wherein the rubber component of the rubber-based adhesive is polyisobutylene rubber and/or butyl rubber.

7. The adhesive tape for battery according to claim 5, wherein the adhesive composition contains a rubber-based adhesive and a saturated hydrocarbon resin.

8. The adhesive tape for battery according to claim 7, wherein the saturated hydro-carbon resin is a hydrogenated petroleum resin.

9. The adhesive tape for battery according to claim 1, wherein the thickness of the adhesive layer is 1 to 50 μm.

10. The adhesive tape for battery according to claim 1, wherein the base is a plastic film.

11. The adhesive tape for battery according to claim 1, wherein the thickness of the base is 4 to 200 μm.

12. The adhesive tape for battery according to claim 1, wherein the adhesive layer is laminated on the inside at a distance of 0.5 mm or more from the both edge portions of the base.

13. The adhesive tape for battery according to claim 1, wherein the retention of peeling strength measured by the following method is 70 to 150%:
(Retention of Peeling Strength)
To a surface of an adhesive tape (1) on which a release agent has been applied, the adhesive layer side of the same adhesive tape (2) is pasted, and they are aged at 23° C. for 20 hours, then, peeled. Then, the peel adhesion (a) to SUS plate of the adhesive tape (2) according to JIS Z 0237:2000 and the peel adhesion (b) to SUS plate of the adhesive tape (2) when peeled without aging are measured, and the retention of peeling strength is calculated by the following equation.
Retention of peeling strength(%)=(a/b)×100%.
